(19) United States
(12) Patent Application Publication
(10) Pub. No.: US 2022/0410583 A1
(43) Pub. Date: Dec. 29, 2022

(54) INK-JET RECORDING APPARATUS AND INK-JET RECORDING METHOD TO DETERMINE INK AMOUNT USING BAR CODE

(71) Applicant: CANON KABUSHIKI KAISHA, Tokyo (JP)

(72) Inventors: Yuto Kajiwara, Kanagawa (JP); Junichi Nakagawa, Tokyo (JP)

(21) Appl. No.: 17/849,526

(22) Filed: Jun. 24, 2022

(30) Foreign Application Priority Data
Jun. 29, 2021 (JP) 2021-108172

(51) Int. Cl. B41J 2/175

(52) U.S. Cl. CPC B41J 2/17566

(57) ABSTRACT

An ink-jet recording apparatus includes a recording unit, a scanning unit, an acquisition unit, and a determination unit. In the recording unit, a plurality of nozzles to apply ink is arrayed. The scanning unit is configured to perform relative scanning with the recording unit on a recording medium. The acquisition unit is configured to acquire input image data that includes a bar code including a plurality of black bars and a plurality of white bars and having a length in a first direction that is greater than a length in a second direction crossing the first direction. The determination unit is configured to determine, based on lengths of the plurality of white bars in the second direction, an amount of ink to be applied to a black bar adjacent to a corresponding white bar in the second direction.

### BACKGROUND

### Technical Field

One disclosed aspect of the embodiments relates to an ink-jet recording apparatus for recording an image on a recording medium and an ink-jet recording method for recording the image on the recording medium.

### Description of the Related Art

In recent years, there has been known an ink-jet recording apparatus that executes multi-pass recording to record an image by performing scanning on a unit area a plurality of times. Such an ink jet recording apparatus performs control such that conveyance control of a recording medium and scanning of a carriage on which a recording head is mounted are repeatedly performed, thereby recording an image on the recording medium.

Japanese Patent Application Laid-Open No. 2002-150211 discusses a recording system that records a bar code. The bar code recorded in the recording medium is assumed to be optically read, so that recording of a highly accurate bar code image is required.

Japanese Patent Application Laid-Open No. 2010-91590 discusses a recording system that records a bar code using an electrophotographic method. Japanese Patent Application Laid-Open No. 2010-91590 discusses a technique of, to record a highly accurate bar code image using the electrophotographic method, referring to a width of a white bar on each side of a black bar and performing correction so as to reduce a width of the black bar in a case where the widths of the white bars are large.

### SUMMARY

The disclosure is directed to provision of a recording apparatus capable of recording an image that includes a bar code with high image quality, in which a change in width of a white bar region caused by bleeding of ink a recording material is suppressed.

An ink-jet recording apparatus includes one or more processors and one or more memories coupled to the processors storing instructions that, when executed by the processors, cause the processors to function as, a recording unit, a scanning unit, an acquisition unit, and a determination unit. In the recording unit, a plurality of nozzles to apply ink is arrayed. The scanning unit is configured to perform relative scanning with the recording unit on a recording medium. The acquisition unit is configured to acquire input image data that includes a bar code including a plurality of black bars and a plurality of white bars and having a length in a first direction that is greater than a length in a second direction crossing the first direction. The determination unit is configured to determine, based on lengths of the plurality of white bars in the second direction, an amount of ink to be applied to a black bar adjacent to a corresponding white bar in the second direction. In a case where a length in the second direction of a first white bar adjacent to a first black bar is a first length, the determination unit is configured to determine an amount of ink to be applied per unit area of an edge region of the first black bar, which is adjacent to the first white bar, as a first amount of ink. In a case where a length in the second direction of a second white bar adjacent to a second black bar is a second length that is less than the first length, the determination unit is configured to determine an amount of ink to be applied per unit area of an edge region of the second black bar, which is adjacent to the second white bar, as a second amount of ink that is smaller than the first amount of ink.

Further features of the disclosure will become apparent from the following description of exemplary embodiments with reference to the attached drawings.

### BRIEF DESCRIPTION OF THE DRAWINGS

FIG. 1 is a diagram schematically illustrating an ink-jet printer.

FIG. 2 is a schematic view of a recording head when observed from a surface on which nozzles are formed.

FIG. 3 is a block diagram illustrating a control configuration of an ink-jet recording system.

FIG. 4 is a block diagram illustrating a recording system.

FIG. 5 is a flowchart illustrating image data processing performed by an image processing apparatus.

FIG. 6 is a diagram illustrating a width of a white bar and a density of a black bar on each side of the white bar in a bar code.

FIGS. 7A and 7B are diagrams each illustrating a state where a density of a black bar on each side of a white bar is changed in accordance with the white bar in the bar code.

FIG. 8 is a diagram illustrating a width of a white bar and the number of pixels to be thinned out at an edge portion of a black bar on each side of the white bar in the bar code.

FIG. 9 is a diagram illustrating a state where an edge portion of a black bar on each side of a white bar is thinned out in accordance with the white bar in the bar code.

FIG. 10 is a diagram illustrating a width of a white bar and the number of dots of a black bar on each side of the white bar in the bar code.

FIG. 11 is a diagram illustrating a state where the number of dots of a black bar on each side of a white bar is changed in accordance with the white bar in the bar code.

FIG. 12 is a diagram illustrating a width of a white bar and a dot size of a black bar on each side of the white bar in the bar code.

FIG. 13 is a diagram illustrating a state where a dot size of a black bar on each side of a white bar is changed in accordance with the white bar in the bar code.

FIG. 14 is a diagram illustrating an example of a recording operation in multi-pass scanning

### DESCRIPTION OF THE EMBODIMENTS

Exemplary embodiments will be described below with reference to the accompanying drawings. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above

A first exemplary embodiment is described. The following description will be given based on the assumption that image processing is executed in a main body of a printer, but this is merely an example for embodying the disclosure, and the disclosure is not limited to the following exemplary embodiment.

### Description of Ink-jet Recording Apparatus

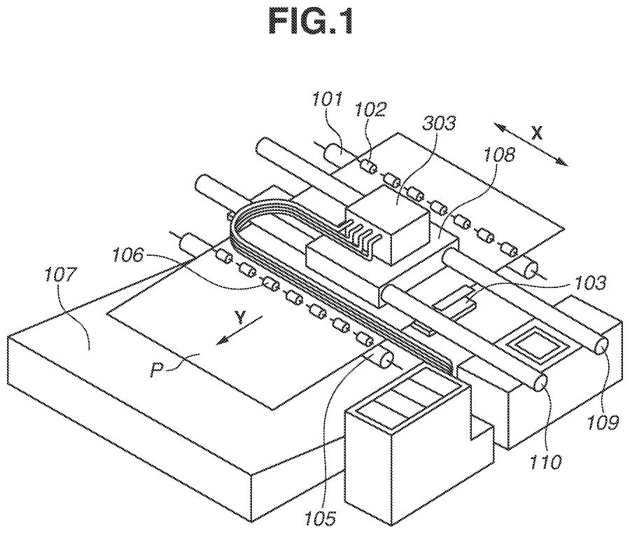

FIG. 1 is a schematic diagram illustrating a recording apparatus according to the present exemplary embodiment. The recording apparatus is an ink-jet printer using a serial recording method, and executes multi-pass recording. In the multi-pass recording, the recording apparatus completes recording of an image on a unit region by performing relative scanning on a recording medium P a plurality of times using a recording head 303.

The recording medium P fed to a recording unit or circuit is pinched at a nip portion between a conveyance roller 101 arranged on a conveyance route and a pinch roller 102 that follows the conveyance roller 101 and conveyed in a Y direction (sub-scanning direction) indicated by an arrow in FIG. 1 in accordance with rotation of the conveyance roller 101. A platen 103 is arranged at a position facing an ejection port surface on which ejection ports (nozzles) of the recording head 303 of the ink-jet recording type are formed. The platen 103 supports a back surface of the recording medium P from below, and maintains a constant distance between a front surface of the recording medium P and the ejection port surface of the recording head 303.

The recording medium P on which an image is recorded is conveyed in accordance with rotation of a discharge roller 105 in the Y direction while being nipped by the discharge roller 105 and a driven roller 106 that follows the discharge roller 105, and is discharged to a discharge tray 107.

The recording head 303 is detachably mounted on a carriage 108 in such a posture as that the ejection port surface faces the platen 103 and the recording medium P. The carriage 108 is reciprocally moved by driving force of a carriage motor in an X direction along two guide rails 109 and 110. In the course of the movement, the recording head 303 executes an ejection operation for ejecting ink droplets from the ejection ports in accordance with a recording signal, and applies ink onto the recording medium P.

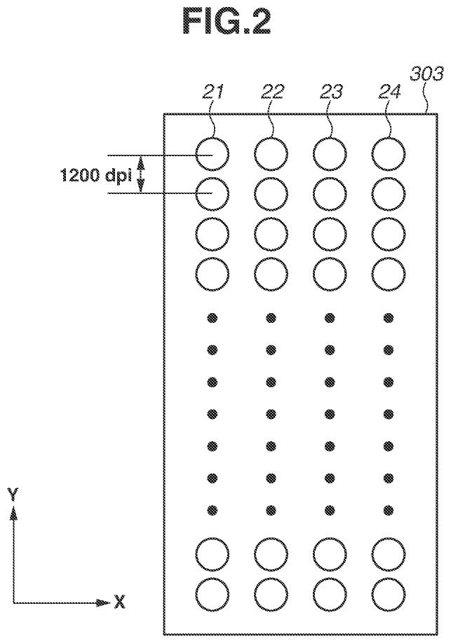

FIG. 2 is a schematic view of the recording head 303 when observed from the ejection port surface side. In the present exemplary embodiment, a cyan nozzle row 21, a magenta nozzle row 22, a yellow nozzle row 23, and a black nozzle row 24 are arrayed in juxtaposition in the X direction as illustrated in FIG. 2. The ejection ports (nozzles) for ejecting ink are arranged at regular intervals in the Y direction on each nozzle row.

A recording element (not illustrated) is arranged inside each ejection port, and the recording element driven by electric energy generates thermal energy. The thermal energy causes ink to foam, and the ink is ejected in the form of droplets from the ejection port. In the following description, a row of a plurality of arrayed ejection ports that ejects an equal amount of ink in an identical color is hereinafter referred to as a nozzle row for simplification.

The X direction, in which the carriage 108 moves, is a direction intersecting with the Y direction in which the recording medium P is conveyed, and is referred to as a main-scanning direction. In contrast, the Y direction in which the recording medium P is conveyed is referred to as the sub-scanning direction. Multi-pass recording that forms an image on the recording medium P in a step-by-step manner is performed by alternately repeating movement of the carriage 108 and the recording head 303 as main-scanning that involves recording and conveyance of the recording medium P (sub-scanning)

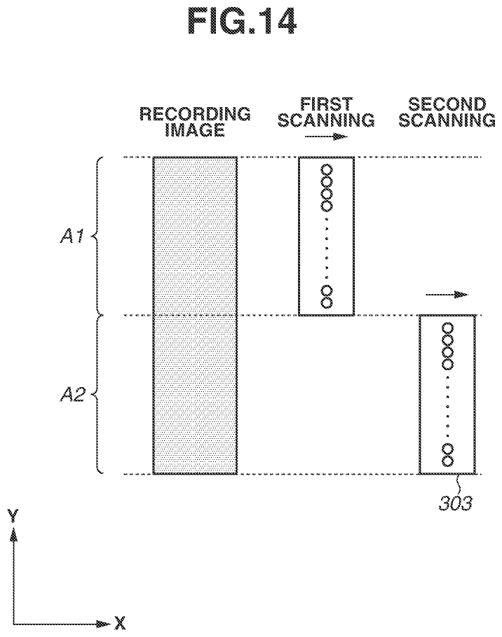

FIG. 14 is a diagram illustrating a relationship between the recording medium P and the ejection ports (nozzles) used for recording an image at the time of multi-pass recording. While the description is given using an example of the black nozzle row 24, the same applies to the other nozzle rows.

First, in first scanning, the recording apparatus executes forward recording to record an image in a region A1 using all the nozzles while moving the recording head 303 together with the carriage 108 in a +X direction (forward direction). After the first scanning, the recording apparatus conveys the recording medium P in a +Y direction. A conveyance amount at this time corresponds to a length of all the nozzles arrayed on the recording head 303. The recording apparatus moves the recording head 303 together with the carriage 108 back in a −X direction, and thereafter executes forward recording in second scanning In the second scanning, the recording apparatus moves the recording head 303 together with the carriage 108 in the +X direction again, and records an image in a region A2 using all the nozzles. After the second scanning, the recording apparatus conveys the recording medium P in the +Y direction. A conveyance amount at this time also corresponds to the length of all the nozzles. Thereafter, the recording apparatus discharges the recording medium P in the +Y direction, and ends the recording operation.

In this manner, the recording method according to the present exemplary embodiment is a one-pass one-way recording method. More specifically, each of the images in predetermined regions (A1 and A2) is completed on the recording medium P by execution of one-way scanning of the recording head 303 one time.

In the above-mentioned example, after performing the first scanning in the +X direction, the recording apparatus moves the recording head 303 back by performing scanning in the −X direction that does not involve the recording operation, and then performs the second scanning in the +X direction. Alternatively, the scanning in the −X direction may be the second scanning involving the recording operation. That is, the recording apparatus conveys the recording medium P in the +Y direction by the amount corresponding tor the length of all the nozzles without moving the carriage 108 and the recording head 303 back in the −X direction after the first scanning Thereafter, the recording apparatus may be configured to record the image in the region A2 using all the nozzles in the second scanning in the −X direction.

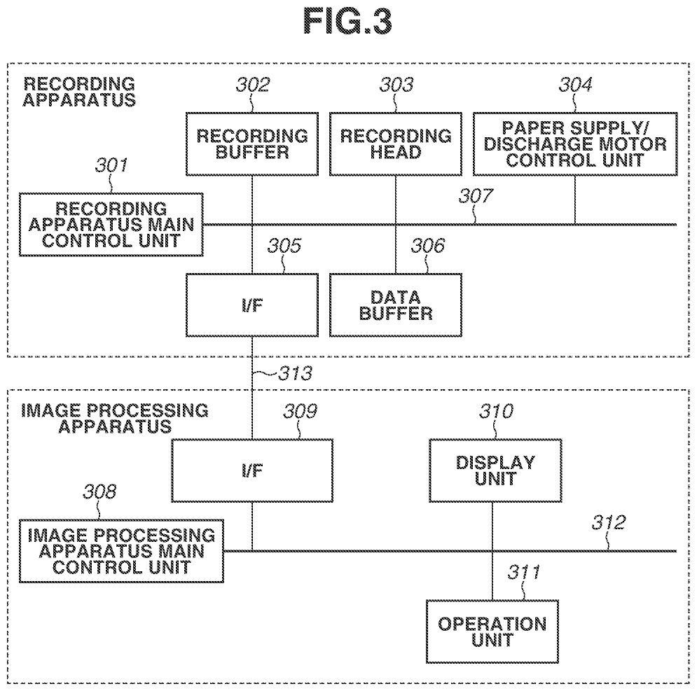

FIG. 3 is a block diagram illustrating a control configuration of an ink-jet recording system according to the present exemplary embodiment. A recording apparatus main control unit or circuit 301 controls the whole of the recording apparatus, and includes a central processing unit (CPU), a read-only memory (ROM), and a random-access memory (RAM). A recording buffer 302 stores image data before the image data is transferred to the recording head 303 as raster data. The recording head 303 is a recording head using the ink-jet recording method including the plurality of nozzles that ejects ink droplets, and ejects ink from each nozzle in accordance with image data stored in the recording buffer 302. A paper supply/discharge motor control unit 304 controls conveyance, supply, and discharge of a recording medium. An interface (I/F) 305 is connected to an image processing apparatus by an I/F signal line 313, and transmits/receives a data signal. A data buffer 306 temporarily stores image data received from the image processing apparatus. A system bus 307 is a bus that connects each function unit of the recording apparatus.

An image processing apparatus main control unit 308 is mainly in charge of creating an image and controlling image data in the image processing apparatus, and includes a CPU, a ROM, and a RAM. An I/F 309 transmits and receives a data signal to and from the recording apparatus. A display unit or circuit 310 displays various kinds of information to a user, and for example, a liquid crystal display (LCD) can be used for the display unit 310. An operation unit or circuit 311 is an operation unit that accepts an operation and an instruction from the user, and for example, a keyboard or a mouse can be used for the operation unit 311. A system bus 312 is a bus that connects the image processing apparatus main control unit 308 and each function unit.

### Description of Overview of Recording System

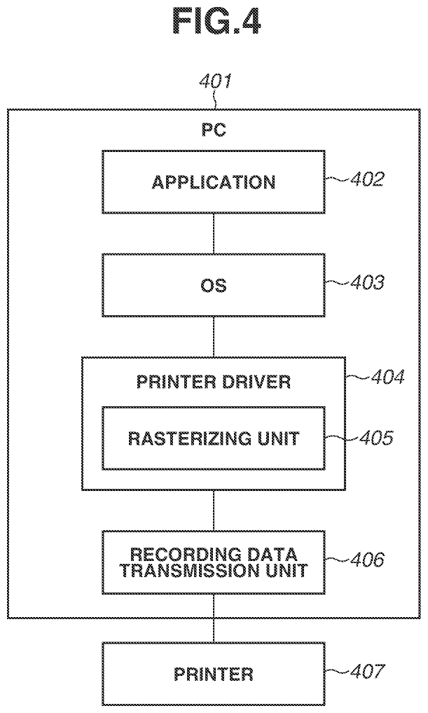

FIG. 4 is a block diagram illustrating an overview of the recording system according to the present exemplary embodiment. The recording system illustrated in FIG. 4 includes a personal computer (PC) 401 serving as a host, and a recording apparatus (printer) 407 that records an image based on recording data transmitted thereto from the PC 401. The PC 401 includes an application 402, an operating system (OS) 403, a printer driver 404, and a recording data transmission unit 406. In the present exemplary embodiment, the recording data transmitted to the printer 407 is recording data including a bar code image.

The application 402 is an application that enables insertion of bar code data in an image. In accordance with an instruction from the printer driver 404, the application 402 converts a function necessary for image processing that is provided by the OS 403 and data obtained by the application 402 together into recording data.

The printer driver 404 rasterizes the received recording data (converts the recording data into bitmap data) in a rasterizing unit 405, and converts the recording data into recording data in a format that can be received by the printer 407. The converted recording data is transmitted to the recording data transmission unit 406, and then transmitted to the printer 407.

Subsequently, a description is given of processes to be performed until a predetermined character string is transmitted as bar code data to the printer 407 in the recording system according to the present exemplary embodiment.

The bar code data is image data including a bar code composed of a combination of black bars and white bars. The bar code image is generated by conversion of the predetermined character string into a format composed of the black bars and the white bars using a bar code font.

When the character string is input to the application 402, the printer driver 404 is called via the OS 403. A request for bar code font information stored in the printer driver 404 is made, and a bar code font designated by the user is set.

The bar code font information includes the name of a bar code font selected from a plurality of bar code types registered in advance and a height and width of the bar code font. Examples of the bar code font information include a Japanese Article Number (JAN) code, a CODE 39, and a CODE 128. The setting values and image data are transmitted together from the application 402 to the printer driver 404 via the OS 403.

Thereafter, the rasterizing unit or circuit 405 uses the designated bar code font to rasterize the setting values and image data into bar code data composed of a combination of one-dimensional black bars and white bars. The rasterized data is converted into recording data that can be received by the printer 407, and transmitted to the printer 407 via the recording data transmission unit or circuit 406.

While the description has been given of the configuration in which the bar code font of the printer driver 404 is called from the application 402 via the OS 403 in the present exemplary embodiment, the configuration is not limited thereto.

### Description of Overview of Entire Flow

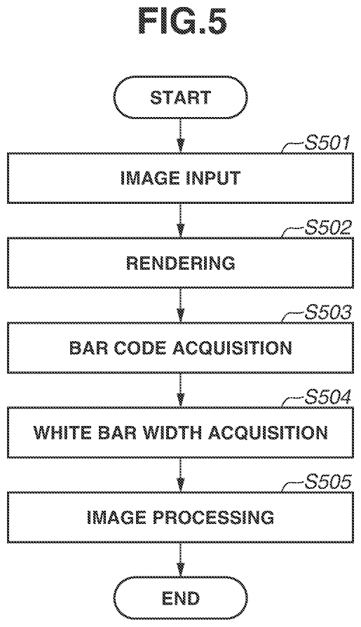

FIG. 5 is a flowchart illustrating image data processing performed by the image processing apparatus according to the present exemplary embodiment.

The processing illustrated in FIG. 5 may be executed by the PC 401 serving as the host, may be executed in the printer 407, or may be partially shared and executed thereby.

In step S501, image data is input. The image data to be input may be vector data or bitmap data.

In step S502, the input image data is rendered. In a case where the input image data is vector data, the vector data is rasterized. In this processing, there may be a case where the image processing apparatus performs mapping and imposition processing in accordance with the size of a recording medium on which an image is to be recorded.

Pixel data corresponding to one row of pixels arrayed in a predetermined direction among pixels arranged in a matrix is referred to as raster data. Furthermore, pixel data corresponding to a plurality of rows of arrayed pixels is referred to as band data.

In a case where the image processing described above is performed in the printer 407, the image processing may be performed with a small capacity of the ROM or the RAM. However, a configuration of sequentially processing the band data is employed in many cases.

In step S503, a bar code acquisition unit or circuit (not illustrated) acquires a position of a bar code region. A method of rasterizing image data using a bar code font may be employed to generate the bar code data. Alternatively, the bar code data may be initially generated as bitmap data or vector data. Hence, the bar code acquisition unit may acquire the bar code information at the time of rendering in step S502, or may detect the bar code information from edge information after converting the image data into the bitmap data. In addition, there may be employed a method in which the user designates the bar code information on a panel or on the host side, and a method is not specifically limited in the present exemplary embodiment.

In step S504, a white bar width acquisition unit or circuit (not illustrated) acquires a width of each white bar code region included in the bar code.

While a mechanism of the bar code will be described below, there are several types of widths of white bars. The white bar width acquisition unit acquires information about the type of each white bar included in the bar code region acquired in step S503. The white bar width acquisition unit may directly acquire information about a width when the bar code is generated using the bar code font, or may acquire the information as the number of pixels from information about a line profile that is orthogonal to a black bar or a white bar after the image data is converted into the bitmap data. An acquisition method is not specifically limited.

In step S505, the image processing apparatus performs image processing for converting the image data into image data in a format that can be recorded by the printer 407. In the present exemplary embodiment, the image processing apparatus converts the image data generated in step S504 into image data corresponding to a color gamut of the printer 407.

The image data to be input is data that represents color coordinates of red (R), green (G), and blue (B) in a color space coordinate system, such as standard RGB (sRGB) color space, which are colors that can be expressed by the monitor. Using a known method such as matrix calculation processing or processing using a three-dimensional look up table (LUT), the image processing apparatus converts the input R, G, and B image data each having eight bits into (R, G′, and B′) image data in the color gamut of the printer 407.

Subsequently, the image processing apparatus converts the R′, G, and B′ image data each having eight bits into image data based on color signal data of ink used in the printer 407. In the present exemplary embodiment, black (K) ink, cyan (C) ink, magenta (M) ink, yellow (Y) ink are used. For this reason, the image processing apparatus converts the image data composed of R, G, and B signals to image data composed of K, C, M, and Y color signals each having eight bits. This color conversion is also performed by making combined use of a three-dimensional LUT and interpolation calculation. As another conversion method, a method such as the matrix calculation processing may be used as in the conversion described above. The number of colors of ink is not limited to four colors of K, C, M, and Y. Other types of ink such as a low density color ink of light cyan (Lc), light magenta (Lm), and gray (Gy), transparent ink, and special color ink may be used by the printer.

Subsequently, the image processing apparatus performs processing of correcting the image data composed of color signals each having eight bits to adjust the number of dots recorded in the recording medium. Since a relationship between the number of dots recorded in the recording medium and an optical density that is obtained by the number of dots on the recording medium is not a linear relationship, the correction processing is performed to make the number of dots and the optical density in an linear relationship. As a method of converting input data into output data in this adjustment processing, a one-dimensional LUT can be used.

Subsequently, the image processing apparatus performs quantization processing on image data representing ink colors each having eight bits and having 256 values. With the quantization processing, one-bit binary data, which is either “1” indicating recording or “0” indicating non-recording, is generated for each pixel. Output of the quantization processing may be the number of ink droplets per unit area, and is not limited to the one-bit binary data of either “1” indicating recording or “0” indicating non-recording. The image processing apparatus may be configured to perform the quantization processing to quantize the image data to multi-valued data of two or more bits. As a method of quantization processing, an error diffusion method and a dithering method have been known, and any other methods may be used.

The image processing apparatus applies ink based on the image data generated in step S505, and the image is thus recorded on the recording medium.

### Description of Bar Code

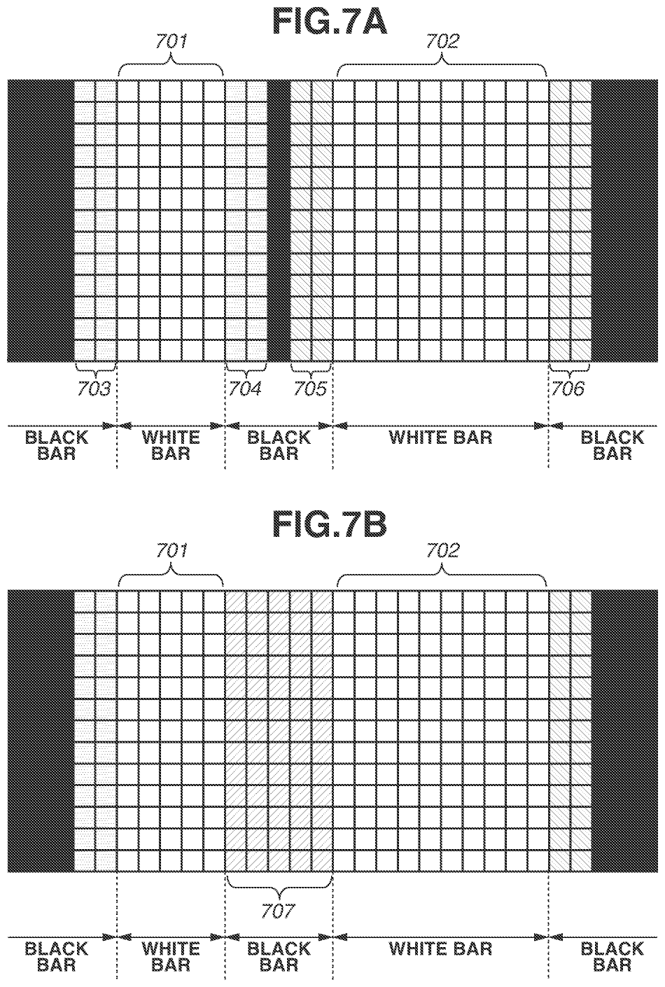

The bar code is composed of a combination of a plurality of black bars and a plurality of white bars, and each bar has a rectangular shape having two sets of parallel sides. That is, a length of a side forming the rectangle is greater than a length of another side that is orthogonal to the side. Reflectance data of the black bars and white bars aligned in a direction orthogonal to the long sides of bars, that is, a direction in which the short sides of bars are aligned, is read as bar code data. In the present specification, a length orthogonal to the longer sides of each bar, that is, a length of the short sides thereof is referred to as a “width” of each bar. The length in the left and right direction in FIG. 7, which will be described below, is the “width” of a bar.

The minimum unit of the width of the black bar or the white bar is called a basic module width or a minimum element width, and the bar code is configured with this width serving as a reference. The width of the black bar or the white bar has a different characteristic depending on a type of the bar code. A binary level bar code is composed of widths in two stages (up to two times the reference), and a multi-level bar code is composed of widths of a plurality of types, such as four stages (up to four times the reference). Typically, the multi-level bar code has a greater number of types of widths than that of the binary level bar code. Hence, the multi-level bar code has a narrow permissible range of a variation in width, and requires higher recording accuracy.

In each of the left and right regions of the bar code, it is necessary to arrange a marginal region called a quiet zone.

A necessary size of the marginal region is different depending on a type of the bar code. If the marginal region has a size smaller than the necessary size, there is a possibility that the bar code image is not correctly read as the bar code.

A red light source is used in a reader for reading the bar code. light is emitted from the light source toward the bar code, and the light reflected from the bar code is read. Thus, to read the bar code appropriately, the color of a black bar region is to be a color that absorbs a wavelength of red color, and the color of a white bar region is to be a color that reflects the wavelength of red color. While bar codes are typically composed of black bars and white bars in many cases, the black bars may have a different color other than black, such as blue and green, and are only required to be formed in a color that absorbs the wavelength of red color. Ink that forms the black bar is not limited to achromatic color ink such as black ink, and process black ink having a color mixture of achromatic colors of cyan, magenta, and yellow may form the black bar. Alternatively, the white bar may be formed in a color that reflects the wavelength of red color such as red and yellow. Hence, a color that forms the black bar may not be black. In addition, a color of the white bar may not be white, and ink may be applied to a space region that is referred to as the white bar.

In order for the bar code reader to read the bar code appropriately, elements required for the quality of the recorded bar code are standardized by International Standards Organization (ISO)/International Electrotechnical Commission (IEC) 15416 as described below.

The minimum reflectance is a reflectance that has the lowest value in the entire bar code. The minimum reflectance having a value lower than or equal to 50% of a maximum reflectance means that the bar code can be read.

A symbol contrast is a difference between the maximum reflectance and the minimum reflectance of the entire bar code.

The symbol contrast is represented by a value obtained by subtracting a reflectance of the darkest portion of the black bar from a reflectance of the brightest portion of the white bar. If the value of the symbol contrast is larger, the bar code can be read more easily.

A minimum edge contrast is a minimum value among the values of differences between a reflectance of a white bar and a reflectance of a black bar adjacent to the white bar. If the minimum value is greater than or equal to 15%, the bar code can be read.

Modulation is a ratio of the minimum edge contrast to the symbol contrast. If a difference between the reflectance of the white bar and the reflectance of the black bar adjacent to the white bar becomes larger, the bar code can be read more easily.

A defect is a void in the black bar or a smear (spot) in the white bar. When there occur a peak portion representing the maximum reflectance in the white bar and a valley portion opposite to the peak and causing unevenness, and a difference between the maximum reflectance in the peak portion and a reflectance in the valley portion is smaller, it means that the bar code easier can be read more easily. In the black bar, a peak portion and a valley portion are reversed from those of the white bar.

Decodability is a tolerance range used when a value is obtained according to a decoding rule defined in each bar code. When actually measured values of the width of the black bar and the width of the white bar are closer to a theoretical value, reading of the bar code becomes easier.

### Issue of Bar Code Recording

Among the above-mentioned elements, the modulation can pose an issue in the ink jet recording apparatus. In the bar code image recorded by the ink jet recording apparatus, there is a case where a width of a black bar region constituting the bar code becomes larger due to bleeding of ink.

Since the bar code is formed by a black bar and two white bars adjacent to the black bar, the white bar region is deformed due to bleeding of ink of the black bar.

The bar code is composed of the black bars and the white bars having a plurality of types of widths, especially occurrence of the above-mentioned issue in the white bar region having a smaller width leads to a failure in obtaining of a sufficient reflectance. Reduction in reflectance of the white bar region reduces a difference from the reflectance of the adjacent black bar and reduces the modulation, resulting in a failure in reading the bar code correctly.

In addition, to address the bleeding of ink, it is effective to reduce an amount of ink applied per unit area. However, since the symbol contrast is required for the bar code, the minimum reflectance is reduced if thinning-out processing for reducing ink uniformly is performed. As a result, the bar code cannot be read correctly as in the case of the above-described issue.

A characteristic configuration of the present exemplary embodiment to solve the above-mentioned issue is described below.

### Description of Characteristic Recording Control

In the present exemplary embodiment, density correction is performed on black bars on respective sides of a white bar based on information indicating a width of the white bar in the bar code acquired in step S504 to suppress reduction in reading performance of the bar code.

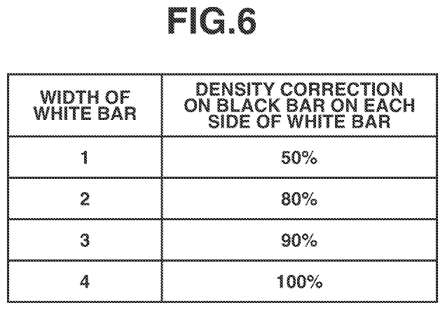

FIG. 6 illustrates a table indicating a combination of a width of a white bar and a density correction value used for density correction on a black bar on each side of the white bar in the multi-level bar code. In a case where the width of the white bar is “1”, the width indicates a basic width (minimum width) in the bar code, and is the most likely to cause deformation in the bar code. Hence, in order to suppress blurring of the black bar on each side, an amount of ink applied to the black bar is corrected to the smallest amount. Widths of white bars are in accordance with the multi-level bar code configuration in the description below. For example, in a case where the width of the white bar is “2”, it indicates that the white bar area has a width that is twice the basic width. An amount of ink applied to form the black bar adjacent to the white bar is corrected to be a larger amount as the width of the white bar becomes larger. As a result, high quality can be maintained in both the modulation and the symbol contrast of the bar code.

Density correction on the black bar on each side of the white bar can be implemented if, for example, the correction is executed after conversion of the eight-bit image data with the use of the one-dimensional LUT in step S505. In this case, quantization processing is performed on the corrected image data and ink is applied based on the recording data that has undergone the quantization processing, and therefore bleeding of ink can be suppressed in recording of the bar code.

FIG. 7A is a diagram illustrating a state where correction is performed on an amount of ink applied to the black bar on each side of the white bar based on the width of the white bar in the bar code. The description is given here assuming that a black pixel region is a black bar region that has a density of 100% and indicates that all of the pixels have a value of “1” indicating recording, and a white pixel region represents a white bar region.

In FIG. 7A, a region 701 is a white bar region having the basic width, that is, the minimum width, and a region 702 is a white bar region having a width twice the basic width. As described above, the width of the white bar in the region 701, when bleeding occurs in ink forming the black bar on each side of the white bar, may become smaller than the basic width, and thus there is a possibility that the region 701 cannot be read as the white bar. For this reason, in the example illustrated in FIG. 7A, density correction is performed on edge regions of the two black bars on the respective sides of the region 701. Specifically, density correction is performed on regions 703 and 704 corresponding to the edge regions of the black bars adjacent to the white bar in the region 701 such that the densities of the regions 703 and 704 are corrected to 50%.

Similarly, the white bar indicated in a region 702 is a region having a width twice the basic width. Hence, density correction is performed on regions 705 and 706 corresponding to edge regions of two black bars on both sides of the white bar such that the densities of the regions 705 and 706 are corrected to 80%.

Since density correction is not performed on a non-edge region located on the inner side of the edge region of the black bar, the density remains 100% and the pixels remain black pixels.

In the example illustrated in FIG. 7A, density correction is performed on the black bars on the respective sides of the white bar region in accordance with the width of the white bar region, so that there is a case where density correction is performed differently on the region 704 and the region 705 in the same black. That is, the edge regions in the periphery of the long sides that form the black bar are different in density. While density correction is performed on the two-pixel wide edge region of each black bar adjacent to the white bar, the range that is regarded as the edge region is not limited thereto, and the edge region may be a one pixel wide region.

FIG. 7B illustrates another example of the present exemplary embodiment. Assuming that a certain black bar has a density of 50% on one of the long sides thereof and a density of 80% on the other of the long sides thereof, interpolation calculation is performed based on widths of white bars on respective sides of the black bar. As a result, as illustrated in a region 707, the entire region of the black bar is corrected to have a density of 65%, and the non-edge region is also subjected to density correction.

A difference from the method discussed in Japanese Patent Application Laid-Open No. 2010-91590 is now described. Japanese Patent Application Laid-Open No. 2010-91590 aims to solve an issue that there occurs a variation in width between recorded black bars depending on widths of white bars adjacent to the respective black bars, even if the black bars have an identical width on image data. To address this issue, the width of a black bar is corrected based on a sum of widths of white bars on the respective sides of the black bar. At this this time, the correction is performed so that the adjacent black bar becomes thinner as the width of the white bar is larger. Regions referred to in this correction are one black bar and adjacent white bars on the respective sides of the black bar.

In the present exemplary embodiment, on the other hand, the issue to be solved is that a white bar that has a small width is deformed due to bleeding of ink. To address this issue, an amount of ink to be applied to adjacent black bar regions on the respective sides of a white bar is adjusted in accordance with a width of the white bar. At this time, the image processing apparatus performs correction so that the amount of ink to be applied to the black bar regions on the respective sides of the white bar is adjusted to be smaller as the width of the white bar becomes smaller. Regions referred to in this correction are one white bar and black bars on the respective sides of the white bar.

In this manner, in the present exemplary embodiment, the amount of ink to be applied to the two black bars adjacent to the white bar is determined based on the width of the white bar. Specifically, the amount of ink to be applied per unit area is reduced such that the density of black becomes lower than that on the original image data. At this time, regions in which the amount of ink is reduced may be only regions on edge portions (edge regions) of the black bars adjacent to the white bar, or may be the entire black bars. In a case where the density of each of the entire black bars is reduced, a ratio of reducing the density of one of the edge regions that constitute the respective black bars and a ratio of reducing the density of the other edge region are different depending on the width of an adjacent white bar. Thus, the density of each of the entire black bars may be adjusted to an intermediate value uniformly or may be adjusted to change by gradation.

In the example illustrated in FIG. 7A, the processing of reducing the amount of ink to be applied per unit area is performed to adjust the density of each of the regions 703 and 704 that are the edge portions of the black bars adjacent to the white bar in the region 701 to 50%. By reducing the amount of ink in at least one of the region 703 and the region 704, the issue that the width of the white bar becomes smaller can be prevented. The same applies to the regions 705 and 706.

In a case where an ink jet recording apparatus records an image, applied ink temporarily stays on the surface of the recording medium, such as paper, in an overflow state before the ink is absorbed in the recording medium, thereby causing bleeding of ink. For this reason, to prevent the bleeding of ink, it is important to perform such correction as to reduce an amount of ink in a surface region, instead of performing local correction. In the present exemplary embodiment, density correction is performed on adjacent black bars on the respective sides of a white bar region in accordance with the width of the white bar region. In a case where there is a possibility that the white bar becomes further thinner due to bleeding of ink and hence the bar code cannot be read, the amount of ink to be applied to the adjacent black bars is reduced. In a case where the white bar has a sufficiently large width, on the other hand, the amount of ink to be applied to the black bars on the respective sides of the white bar is increased as compared with the case of the white bar having a small width. With this processing, it makes it possible to prevent reduction in modulation in a bar code image while maintaining a contrast between a black bar and a white bar in the bar code image. As a result, it is possible to record the bar code having high reading accuracy.

Subsequently, a second exemplary embodiment is described. A description about a configuration similar to that in the first exemplary embodiment is omitted, and only parts different from the first exemplary embodiment are described.

In the above-mentioned first exemplary embodiment, a density per unit area of ink to be applied to the black bar region on each side of the white bar is determined based on the width of the white bar in the bar code. In the present exemplary embodiment, processing of thinning out is performed on an edge region of a black bar on each side of a white bar based on a width of a white bar region in a bar code to reduce a widths of black bars to be recorded.

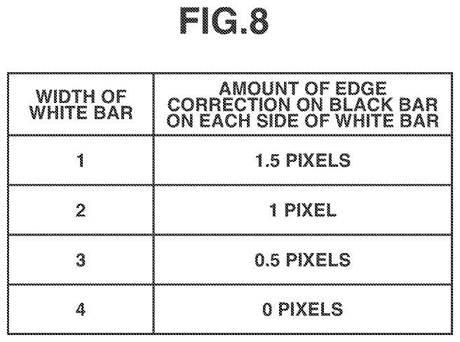

FIG. 8 illustrates a table indicating a combination of a width of a white bar and edge correction on a black bar on each side of the white bar in the multi-level black bar. If the width of the white bar is “1”, this indicates a minimum unit width of the white bar, and it is highly likely that the bar code cannot be read due to bleeding of ink. In the present exemplary embodiment, thinning-out processing is performed on the edge regions of the adjacent black bars on the respective sides of the white bar having the width of “1”. In this processing, one-and-a-half pixels are thinned out from the edge region corresponding to two pixels. Thinning of one-and-a-half pixels from two pixels means that three pixels out of four pixels, that is, 75% of pixels are thinned out from edge pixels. The one-and-a-half pixels are a maximum value of a thinning-out amount. The number of pixels to be thinned out is reduced as the width of the white bar becomes larger. With this processing, it is possible to maintain a high symbol contrast while maintaining modulation.

The edge correction on the two black bars located on the respective sides of the white bar can be implemented by execution of processing such as masking on the image data input at the beginning in step S505.

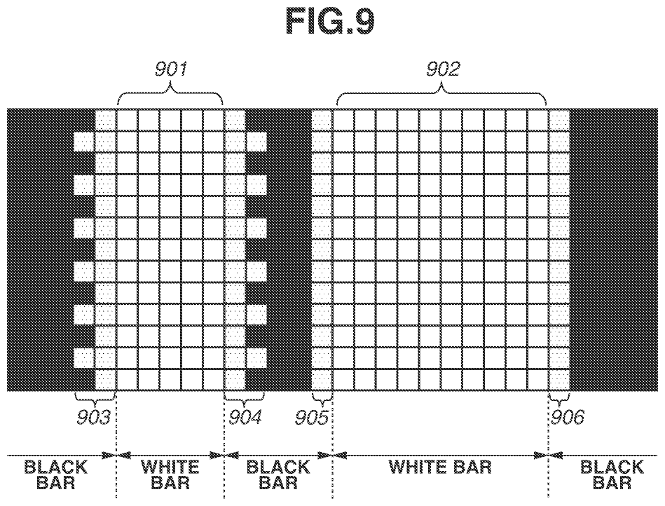

FIG. 9 is a diagram illustrating a state where edge correction is performed on the two black bars on the respective sides of the white bar based on the width of the white bar in the bar code. A region 901 is a white bar region having the basic width, and a region 902 is a white bar region having a width twice the basic width. Since the region 901 corresponds to a white bar having the basic width, edge correction is performed on the regions 903 and 904 corresponding to the edge regions of the black bars on the respective sides of the white bar to thin out the edge regions by one-and-a-half pixels. On the other hand, since the white bar in the region 902 has the width twice the basic width, edge correction is performed on regions 905 and 906 corresponding to the edge regions of the two black bars on the respective sides of the white bar to thin out the regions by one pixel. That is, since the edge region corresponding to two pixels in each of the regions 905 and 906 is thinned out by one pixel, 50% of pixels are substantially thinned out.

In the present exemplary embodiment, processing of thinning out the edge regions of the two black bars on the respective sides of the white bar in accordance with the width of the white bar region. At this time, since there is a possibility that a white bar having a small width is deformed due to bleeding of ink and hence the bar code cannot be read, a ratio of thinning-out on the adjacent black bars is set to a higher ratio as the white bar has a smaller width. In a case where the white bar has a sufficiently large width, on the other hand, a ratio of thinning-out on the adjacent black bars is reduced as compared with the case of the white bar having a small width. With this processing, it makes it possible to prevent reduction in modulation of a bar code image while maintaining a contrast between a black bar and a white bar in the bar code image. As a result, it is possible to record the bar code with high reading accuracy.

The thinning-out processing is performed only on the regions corresponding to the edge portions of the black bars in the present exemplary embodiment, but the thinning-out processing may be performed uniformly on the entire black bars as in the first exemplary embodiment. Alternatively, the thinning-out processing may be performed on only one of the black bars on the respective sides of the white bar.

Subsequently, a third exemplary embodiment is described. Also in the present exemplary embodiment, a description of a configuration similar to that in the first exemplary embodiment is omitted, and only parts different from the first exemplary embodiment are described.

In the present exemplary embodiment, processing of reducing the number of dots in each of edge regions of black bars on the respective sides of a white bar is performed based on a width of the white bar region in the bar code.

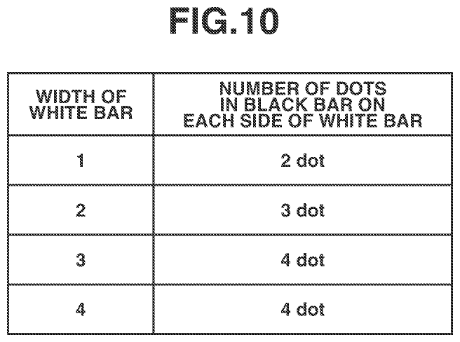

FIG. 10 illustrates a table indicating a combination of a width of a white bar and the number of dots of ink applied at the time of recording adjacent black bars on the respective sides of the white bar in the multi-level bar code. Assume that four dots of ink are applied to one pixel in a case of normal recording. In a case where the width of the white bar is a minimum unit width of “1”, correction is performed to reduce the number of dots of ink applied to each of the black bars on the respective sides of the white bar. The number of dots per pixel is determined such that the number of dots to be applied becomes the same as that at the time of normal recording if the width of the white bar becomes larger, and therefore it make it possible to keep a high symbol contrast while maintaining modulation. The processing of determining the number of dots to be applied to each of the black bars on the respective sides of the white bar can be implemented by the quantization processing performed at the end of step S505. Specifically, in a case where there is data of “1” indicating recording in a target pixel where the number of dots is to be reduced, the number of dots to be assigned to the target pixel is determined so that the number of dots applied to the pixel is less than the number of dots applied to a normal pixel that is not a target pixel for the reduction. As described above, only the pixels in the edge regions of the black bars may be target pixels that are subjected to the reduction processing, or the reduction target pixels may be those in the entire black bar.

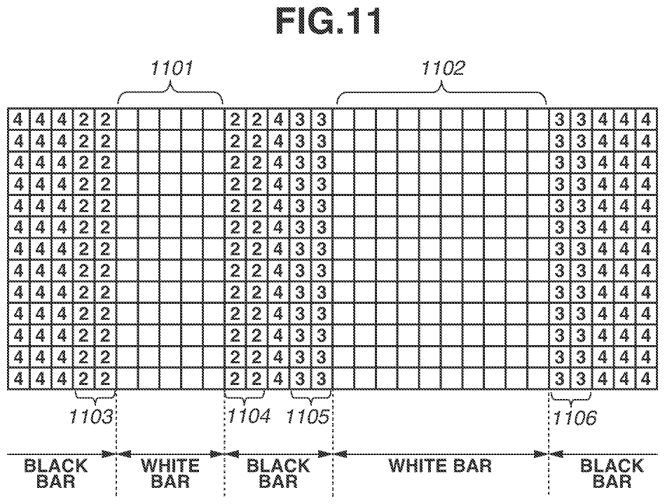

FIG. 11 is a diagram illustrating recording data that has been processed according to the present exemplary embodiment. FIG. 11 illustrates a state where the number of dots of ink applied to each of the black bars located on the respective sides of the white bar is reduced in accordance with the width of the white bar region in a bar code. A numeric value described in each pixel indicates the number of dots of ink to be applied. A region 1101 is a white bar region having the basic width, and a region 1102 is a white bar region having a width twice the basic width. The number of dots is determined so as to apply two dots per pixel to each of regions 1103 and 1104 corresponding to the edge regions of the two black bars located on the respective sides of the white bar in the region 1101. On the other hand, since the white bar in the region 1102 has the width twice the basic width, the number of dots is determined so as to apply three dots per pixel to each of regions 1105 and 1106 corresponding to the edge regions of the two black bars located on the respective sides of the white bar.

In the present exemplary embodiment, reduction processing is performed such that the number of dots of ink to be applied to the two black bars on the respective sides of the white bar is reduced to be less than the number of dots to be applied to a normal region in accordance with the width of the white bar region. At this time, there is a possibility that a white bar having a small width is deformed due to bleeding of ink and hence the bar code cannot be read, so that the number of dots to be applied to a black bar adjacent to the white bar having the small width is reduced. In a case where the white bar has a sufficiently large width, on the other hand, the number of dots to be applied to the adjacent black bar is increased as compared with the case of the white bar having the small width. With this processing, it is possible to maintain a symbol contrast while preventing reduction in modulation in black bars and white bars in the bar code image. As a result, it is possible to record the bar code with high reading accuracy.

Subsequently, a fourth exemplary embodiment is described. Also in the present exemplary embodiment, a description of a configuration similar to that in the first exemplary embodiment is omitted, and only parts different from the first exemplary embodiment are described.

In the present exemplary embodiment, processing of changing a dot size of ink to be applied to edge regions of black bars on the respective sides of a white bar is performed based on a width of the white bar region in the bar code.

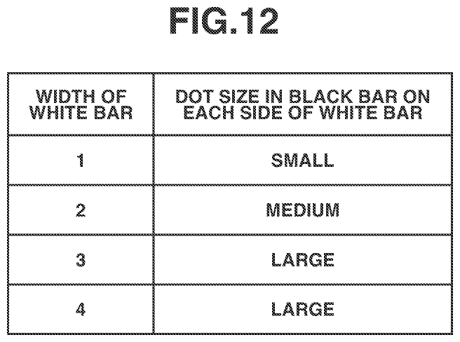

FIG. 12 illustrates a table indicating a combination of a width of a white bar and a dot size of ink applied at the time of recording black bars on the respective sides of the white bar in the multi-level bar code. Assume that recording is performed with large dots with respect to one pixel in a case of normal recording.

In a case where the width of the white bar is a minimum unit width of “1”, the dot size of ink to be applied to each of the black bars on the respective sides of the white bar is reduced. The dot size of ink to be applied to each black bar is determined to be the same as that at the time of normal recording if the width of the white bar becomes larger. With this processing, it is possible to maintain a high symbol contrast while preventing reduction in modulation. The processing of determining the dot size of ink to be applied to each of the black bars on the respective sides of the white bar is implemented by the quantization processing performed at the end of step S505. Specifically, in a case where there is data of “1” indicating recording in a target pixel where the dot size is to be changed, the dot size to be assigned to the target pixel is determined so that the dot size to be applied to the pixel becomes a size that is smaller than the dot size to be applied to a pixel that is not a target for the change.

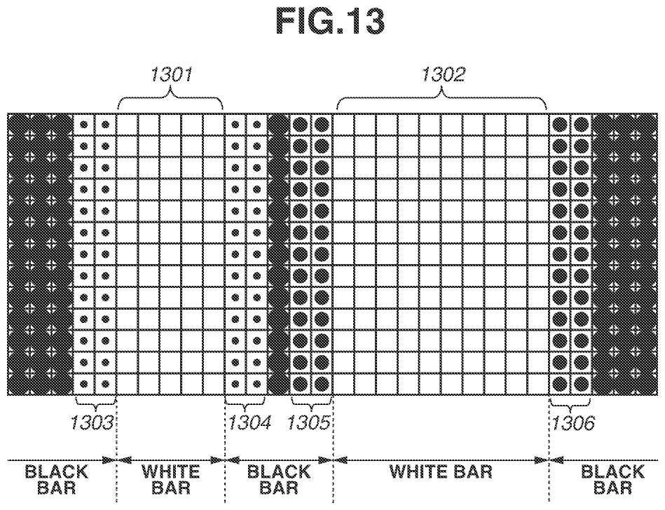

FIG. 13 is a diagram illustrating recording data that has been processed according to the present exemplary embodiment. FIG. 13 illustrates a state where the dot size of ink applied to each of the black bars on the respective sides of the white bar is changed in accordance with the width of the white bar region. A region 1301 is a white bar having the basic width, and a region 1302 is a white bar having a width twice the basic width. In each of regions 1303 and 1304 corresponding to the edge regions of the two black bars on the respective sides of the white bar in the region 1301, the dot size is determined such that recording is performed with a dot of a relatively small size in each pixel. On the other hand, since the white bar in the region 1302 has the width twice the basic width, the dot size is determined such that recording on each pixel is performed with a middle dot that is larger than the small dot in regions 1305 and 1306 corresponding to the edge regions of the black bars on the respective sides of the white bar.

In the present exemplary embodiment, processing of reducing the dot size of ink to be applied to the two black bars on the respective sides of the white bar is performed in accordance with the width of the white bar region. At this time, there is a possibility that a white bar having a small width is deformed due to bleeding of ink and hence the bar code cannot be read, so that the dot size used for recording is reduced with respect to the black bars adjacent to the white bar having a small width. In a case where the white bar has a sufficiently large width, on the other hand, the dot size of ink to be applied to each black bar is increased as compared with the case of the white bar having the small width. With this processing, a high symbol contrast is maintained while preventing reduction in modulation in a bar code image. As a result, it is possible to record the bar code image with high reading accuracy.

### Other Exemplary Embodiments

While the description has been given of the thermal recording head that ejects ink by driving of the recording element in the above-mentioned exemplary embodiments, a piezoelectric recording head that ejects ink by applying a voltage to a piezoelectric element to change the volume may be used.

While the description has been given of the example of a serial printer that records an image while causing the recording head in which the nozzle rows are arrayed in the conveyance direction of the recording medium to perform scanning in the direction crossing the conveyance direction, the recording apparatus is not limited thereto as long as it can record the image by relative scanning of the recording medium with the recording head.

For example, the recording apparatus may be a full multi-type recording apparatus capable of recording the entire region of the recording medium by performing relative scanning one time using a line head in which nozzles are arrayed in the direction orthogonal to the conveyance direction of the recording medium.

Due to the configuration that a bar code is read by reading light reflected from a portion irradiated with light emitted from a light source, the recording apparatus needs not be configured to read the entire region of each bar of the bar code in a longitudinal direction of the bars. That is, as long as the processing described above in the exemplary embodiments is performed only in major part of the edge portions in the bar code, the bar code may include a portion that is not subjected to the processing.

The disclosure enables recording of a high-quality bar code image in which a white bar region included in the bar code is not deformed and prevents reduction in image quality.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-108172, filed Jun. 29, 2021, which is hereby incorporated by reference herein in its entirety.

What is claimed is:

1. An ink-jet recording apparatus comprising:
one or more processors; and
one or more memories coupled to the processors storing instructions that, when executed by the processors, cause the processors to function as:
a recording unit in which a plurality of nozzles to apply ink is arrayed;
a scanning unit configured to perform relative scanning with the recording unit on a recording medium;
an acquisition unit configured to acquire input image data that includes a bar code including a plurality of black bars and a plurality of white bars and having a length in a first direction that is greater than a length in a second direction crossing the first direction; and
a determination unit configured to determine, based on lengths of the plurality of white bars in the second direction, an amount of ink to be applied to a black bar adjacent to a corresponding white bar in the second direction,
wherein, in a case where a length in the second direction of a first white bar adjacent to a first black bar is a first length, the determination unit is configured to determine an amount of ink to be applied per unit area of an edge region of the first black bar, the edge region being adjacent to the first white bar, as a first amount of ink, and
wherein, in a case where a length in the second direction of a second white bar adjacent to a second black bar is a second length that is less than the first length, the determination unit is configured to determine an amount of ink to be applied per unit area of an edge region of the second black bar, the edge region being adjacent to the second white bar, as a second amount of ink that is smaller than the first amount of ink.

2. The ink-jet recording apparatus according to claim 1,
wherein the first white bar is adjacent to a third black bar and positioned between the first black bar and the third black bar, and the second white bar is adjacent to a fourth black bar and positioned between the second black bar and the fourth black bar, and
wherein the determination unit is configured to determine an amount of ink to be applied per unit area of an edge region of the third black bar, the edge region being adjacent to the first white bar, as the first amount of ink, and determine an amount of ink to be applied per unit area of an edge region of the fourth black bar, the edge region being adjacent to the second white bar, as the second amount of ink.

3. The ink-jet recording apparatus according to claim 1,
wherein the determination unit is configured to determine an amount of ink to be applied per unit area in a non-edge region of the first black bar, the non-edge region being not adjacent to the first white bar, as an amount that is larger than the first amount of ink, and
wherein the determination unit is configured to determine an amount of ink to be applied per unit area in a non-edge region of the second black bar, the non-edge region being not adjacent to the second white bar, as an amount that is larger than the second amount of ink.

4. The ink-jet recording apparatus according to claim 1,
wherein the determination unit is configured to determine the first amount of ink for the edge region of the first black bar by reducing a density indicated by the input image data, and
for the edge region of the second black bar by reducing a density indicated by the input image data.

5. The ink-jet recording apparatus according to claim 1,
wherein the determination unit is configured to determine the first amount of ink on the edge region of the first black bar by thinning out recording data generated based on the input image data, and
wherein the determination unit is configured to determine the second amount of ink on the edge region of the second black bar by thinning out recording data generated based on the input image data.

6. The ink-jet recording apparatus according to claim 1,
wherein the determination unit is configured to determine the first amount of ink on the edge region of the first black bar by reducing a size of an ink droplet indicated by recording data generated based on the input image data, and
wherein the determination unit is configured to determine the second amount of ink on the edge region of the second black bar by reducing a size of an ink droplet indicated by recording data generated based on the input image data.

7. The ink-jet recording apparatus according to claim 1, further comprising a detection unit configured to detect the bar code from the input image data.

8. The ink-jet recording apparatus according to claim 1, wherein regions of the plurality of white bars are formed by application of ink.

9. The ink-jet recording apparatus according to claim 1, wherein regions of the plurality of black bars are formed by application of ink of a color other than black.

10. An ink-jet recording method for an apparatus including a recording unit in which a plurality of nozzles to apply ink is arrayed and a scanning unit configured to perform relative scanning with the recording unit on a recording medium, the method comprising:
acquiring input image data that includes a bar code including a plurality of black bars and a plurality of white bars and having a length in a first direction that is greater than a length in a second direction crossing the first direction; and
determining, based on lengths of the plurality of white bars in the second direction, an amount of ink to be applied to a black bar adjacent to a corresponding white bar in the second direction,
wherein, in a case where a length in the second direction of a first white bar adjacent to a first black bar is a first length, the determining includes determining an amount of ink to be applied per unit area of an edge region of the first black bar, the edge region being adjacent to the first white bar, as a first amount of ink, and
wherein, in a case where a length in the second direction of a second white bar adjacent to a second black bar is a second length that is less than the first length, the determining includes determining an amount of ink to be applied per unit area of an edge region of the second black bar, the edge region being adjacent to the second white bar, as a second amount of ink that is smaller than the first amount of ink.
